(19) United States
(12) Patent Application Publication
(10) Pub. No.: US 2012/0278072 A1
(43) Pub. Date: Nov. 1, 2012

(54) REMOTE HEALTHCARE SYSTEM AND HEALTHCARE METHOD USING THE SAME

(75) Inventors: Jeong Je PARK, Hwaseong-si (KR); Kwang Hyeon LEE, Seoul (KR)

(73) Assignee: SAMSUNG ELECTRONICS CO., LTD., Suwon-si (KR)

(21) Appl. No.: 13/431,607

(22) Filed: Mar. 27, 2012

(30) Foreign Application Priority Data
Apr. 26, 2011 (KR) 10-2011-0038817

(51) Int. Cl. G10L 15/26

(52) U.S. Cl. 704/235; 704/E15.043

(57) ABSTRACT

A remote healthcare system includes a healthcare staff terminal which includes an input part configured to input text to be transmitted to a patient by a healthcare staff member, and a first transmitter-receiver part configured to transmit the text and a qualifier of the healthcare staff member; a server which includes a second transmitter-receiver part configured to receive the text and the qualifier of the healthcare staff member transmitted from the healthcare staff terminal, an acoustic source database having an acoustic source of the healthcare staff member stored therein, and a converter configured to change the text into voice using the stored acoustic source of the healthcare staff member; and a patient terminal which includes a third transmitter-receiver part configured to receive the voice converted from the text and the text transmitted by the second transmitter-receiver part of the server, and an output part configured to output the voice to the patient who is managed by the healthcare staff member.

### CROSS-REFERENCE TO RELATED APPLICATION

This application claims priority from Korean Patent Application No. 2011-038817 filed Apr. 26, 2011 with the Korean Intellectual Property Office, the disclosure of which is incorporated herein by reference in its entirety.

### BACKGROUND

1. Field

Apparatuses and methods consistent with exemplary embodiments relate to a remote medical service and, more particularly, a remote healthcare system to transport messages of a medical practitioner to a patient and a healthcare method using the same.

2. Description of the Related Art

Because of an increase in a number of elderly, unhealthy lifestyle choices and/or food habits, the number of people suffering from chronic diseases has increased, in turn causing increases in healthcare expenditures and mortality rate due to such chronic diseases. Accordingly, in order to effectively and economically treat and care for patients with chronic diseases, in particular, elderly patients, a remote medical service system has been proposed to provide a medical service to the patient at home, in an office and/or during movement, without a need of visiting a hospital. As a result, it is possible to conveniently provide medical service at a desired place and/or time without restrictions as to space and time.

Using such a remote medical service system, convenient diagnosis, medication prescription or treatment may be conducted. However, compared to directly visiting a medical center, interaction with medical practitioners may be reduced, thus creating a problem in effective management of healthcare of patients.

### SUMMARY

Exemplary embodiments provide a remote healthcare system and method to effectively manage a patient wherein a healthcare employee, a staff member transmits text to a patient after converting the text into a voice of the staff member.

According to an aspect of an exemplary embodiment, there is provided a remote healthcare system which may include: a terminal for healthcare staff members, which includes an input part for inputting text to be transmitted to a patient by the healthcare staff member and a transmitter-receiver part to transmit the text as well as a qualifier of the healthcare staff member to a server; the server, which includes another transmitter-receiver part to send and receive information from the healthcare staff terminal and/or a terminal for a patient, an acoustic source database having acoustic source of the healthcare staff member stored therein, and a converter to change the text into voice using the stored acoustic source of the healthcare staff member; and the patient terminal, which includes a transmitter-receiver part to receive the voice converted from the text as well as the text from the server, and an output part to output the voice to the patient who is managed by the healthcare staff member.

The healthcare staff terminal may further include an acoustic source generation part to create the acoustic source of the healthcare staff member.

The acoustic source generation part may include: an acoustic source extraction part to isolate from voice of the healthcare staff member inputted in the input part; an acoustic source generation control part to control a process of creating the acoustic source; and a test part to determine whether there is an error in the extracted acoustic source.

The test part may synthesize a sample voice using the extracted acoustic source from the acoustic source extraction part, while the output part may output the sample voice and the input part may receive a determined result as to whether the sample voice input by the healthcare staff member contains an error.

If the input part receives an input indicating that an error is present in the sample voice, the output part may output a word or sentence indicating re-extraction of the acoustic source while the input part may receive again the above word or sentence input by the healthcare staff member.

The acoustic source extraction part may repeat re-extraction of the acoustic source and outputting the sample voice until the input indicating no error present in the sample voice is received and, when the input indicating no error present in the sample voice, transmits the extracted acoustic source to the server through the transmitter-receiver part.

The server may further include an acoustic source detector to detect an acoustic source having a qualifier, which corresponds to an alternative qualifier of the healthcare staff member received from the transmitter-receiver part of the patient terminal, in the acoustic source database.

The converter may change (that is, convert) the text received from the transmitter-receiver part of the healthcare staff terminal into voice using the acoustic source transmitted from the acoustic source detector.

The remote healthcare system may further include a biological information sensor to measure or sense health conditions of a patient and transmit the measured or sensed information to the server or the patient terminal.

The server may further include a decision support system for home healthcare (DSSH) to create text for diagnosis or prescription, using the information regarding the health conditions of the patient transmitted from the biological information sensor or the patient terminal.

The acoustic source detector of the server may detect an acoustic source of the healthcare staff member who manages the information regarding the health conditions of the patient and transmit the detected acoustic source to the converter. Then, the converter of the server may convert the created text in the DSSH into voice, using the detected acoustic source of the healthcare staff member.

According to an aspect of another exemplary embodiment, there is provided a remote healthcare system which may include: a healthcare staff terminal, which includes an input part for inputting text to be transmitted to a patient by the healthcare staff member and a transmitter-receiver part to transmit the text as well as a qualifier of the healthcare staff member to a server; the server having another transmitter-receiver part to send and receive information from the healthcare staff terminal and/or a patient terminal; and the patient terminal, which includes another transmitter-receiver part to receive text information and the qualifier of the healthcare staff member from the server, an acoustic source database having an acoustic source of the healthcare staff member stored therein, a converter to change the text into voice of the healthcare staff member, and an output part to output the converted voice as well as the text.

The patient terminal may further include an acoustic detector which detects an acoustic source having a qualifier corresponding to the qualifier of the healthcare staff member received from the transmitter-receiver part of the server, in the acoustic source database, and then, transmits the detected acoustic source to the converter.

The remote healthcare system may further include a biological information sensor to measure or sense health conditions of a patient and transmit the measured or sensed information to the server of the patient terminal.

The server may further include a decision support system for home healthcare (DSSH) to create a text for diagnosis or prescription, using the information regarding the health conditions of the patient transmitted from the biological information sensor or the patient terminal.

The transmitter-receiver part of the server may transmit the text created in the DSSH and a qualifier of the given healthcare staff member to the patient terminal, while the acoustic source detector may detect an acoustic source of the healthcare staff member who manages information regarding the health conditions of the patient, and then, transmit the detected acoustic source to the converter. Following this, the converter may use the detected acoustic source of the healthcare staff member to convert the text created by the DSSH into voice.

According to an aspect of another exemplary embodiment, there is provided a remote healthcare method which may include: inputting text to be transmitted to a patient by a healthcare staff member; transmitting the text and a qualifier of the healthcare staff member who inputs the text to a server; converting the text into voice of the healthcare staff member; and transmitting the voice of the healthcare staff member as well as the text to the patient.

The conversion of the text into the voice of the healthcare staff member may include: detecting an acoustic source having a qualifier corresponding to the qualifier of the healthcare staff member, in an acoustic source database; using the detected acoustic source to convert the text into the voice of the healthcare staff member.

According to an aspect of another exemplary embodiment, there is provided a remote healthcare method which may include: creating text regarding diagnosis or prescription for a patient in a clinical decision support system (CDSS); converting the created text into voice of a healthcare staff member, which matches with contents of the text; and transmitting the voice of the healthcare staff member converted from the text as well as the created text, to the patient.

The conversion of the created text into the voice of the healthcare staff member matching with the contents of the text, may include: extracting a qualifier of the healthcare staff member matching with the contents of the text; detecting an acoustic source having a qualifier corresponding to the extracted qualifier of the healthcare staff member in an acoustic source database; and using the detected acoustic source to convert the created text into voice.

### BRIEF DESCRIPTION OF THE DRAWINGS

The above and/or other aspects will become more apparent by describing certain exemplary embodiments, with reference to the accompanying drawings, in which:

FIG. 1 is a control block diagram of a remote healthcare system according to an exemplary embodiment;

FIG. 2 illustrates the configuration of a system according to an exemplary embodiment;

FIG. 3 is a control block diagram of a healthcare staff terminal according to an exemplary embodiment;

FIG. 4 is a control block diagram of an acoustic source generating part according to an exemplary embodiment;

FIG. 5 is a schematic view illustrating an acoustic source database according to an exemplary embodiment;

FIG. 6A is a control block diagram of a healthcare staff terminal including a test part according to an exemplary embodiment;

FIGS. 6B, 6C and 6D illustrate an example of using a test part according to an exemplary embodiment;

FIG. 7 is a control block diagram of a server according to an exemplary embodiment;

FIG. 8 is a control block diagram of a server having an acoustic source detector according to an exemplary embodiment;

FIG. 9 is a control block diagram of a patient terminal according to an exemplary embodiment;

FIG. 10 is a control block diagram of a server having a CDSS according to an exemplary embodiment;

FIG. 11 is a control block diagram of a patient terminal having voice conversion function according to an exemplary embodiment;

FIG. 12 is a control block diagram of a server having a CDSS and a patient terminal having voice conversion function according to an exemplary embodiment;

FIG. 13 is a flow diagram illustrating a remote healthcare method according to an exemplary embodiment;

FIG. 14 is a flow diagram illustrating a method of constructing an acoustic source database according to an exemplary embodiment;

FIG. 15 is a flow diagram illustrating a remote healthcare method according to an exemplary embodiment;

FIG. 16 is a flow diagram illustrating a remote healthcare method according to an exemplary embodiment; and

FIG. 17 is a flow diagram illustrating a remote healthcare method according to an exemplary embodiment.

### DETAILED DESCRIPTION

Certain embodiments are described in greater detail below, with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be carried out without those specifically defined matters. Also, well-known functions or constructions are not described in detail since that would obscure the invention with unnecessary detail.

A remote healthcare system according to an exemplary embodiment includes a healthcare staff terminal to which text to be transmitted to a patient is input by a medical practitioner; a server to convert the text into the voice of the healthcare staff; and a patient terminal that receives the text information and the voice information of the healthcare staff member from the server and transfers visible and auditory information to the patient.

The healthcare staff members mentioned herein may include medical practitioners such as a doctor, a nurse, a physical therapist, an oriental doctor, etc., who diagnose, treat and/or fill out a prescription for diseases of patients in medical institutions such as hospitals, in order to care for or manage the patients. In addition, healthcare staff members may include a physical trainer to control a body weight or exercise extent of a patient, a diet manager to manage food habits of the patient, or the like. The healthcare staff members are not limited to the foregoing examples and may include anyone to manage or care for the health of the patient.

The patient mentioned herein is not limited to people suffering from diseases, which need management of medical practitioners and may refer to people registered in a server as subjects to be managed by healthcare staff members, including persons who require management by the healthcare staff to care for health conditions thereof, even though they do not have any disease.

The remote healthcare system is a system for enabling diagnosing a patient or issuing a medical prescription by a healthcare staff member, even though the patient does not visit a healthcare center such as a hospital, and may include a system wherein the patient directly measures health conditions and then transmits results thereof by himself (herself) at a place other than the healthcare center, i.e., at home or in an office.

For instance, a biological information sensor to measure health conditions of a patient such as blood glucose, blood pressure, heart rate, body weight, body fat, etc. may be provided at the patient side. Such a biological information sensor may include any device for measuring the health conditions of the patient, without particularly limiting a configuration thereof.

The biological information sensor may include a transmitter-receiver unit to send and receive information from the patient terminal, in order to transmit measured health conditions of the patient to the patient terminal.

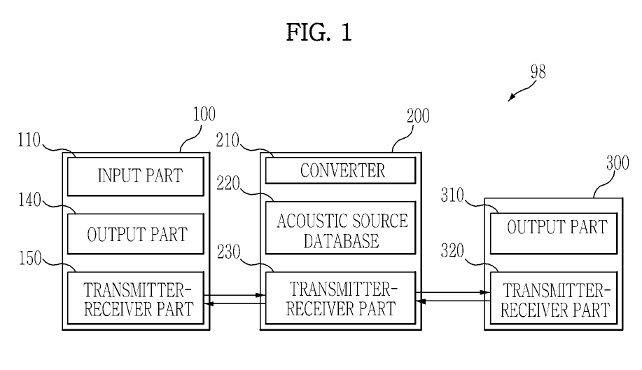

FIG. 1 is a control block diagram illustrating an exemplary embodiment. Referring to FIG. 1, a remote healthcare system 98 may include a healthcare staff terminal 100, a server 200 and a patient terminal 300.

The healthcare staff terminal 100 may include an input part 110 to which a medical practitioner inputs text or the like to be transmitted to a patient, an output part 140 from which information regarding health conditions of the patient is output, and a transmitter-receiver part 150 for transmitting the text to the server 200.

Contents of the text input to the input part 110 may include any things to be provided to a subject or the patient, by the healthcare staff members as, for example, diagnosis of conditions of the patient, prescription based on the diagnosis, details for treating the conditions of the patient, and/or regular confirmation of the conditions, without particular limitation thereto.

The server 200 may include an acoustic source database 220 containing acoustic sources of healthcare staff members stored therein; a converter 210 that uses the acoustic sources of the healthcare staff members to convert text transmitted from the healthcare staff terminal 100 into voice; and a transmitter-receiver part 230 to send and receive information from the healthcare staff terminal 100 and/or the patient terminal 300.

The acoustic source database 220 may contain acoustic sources of the healthcare staff members who use the remote healthcare system stored therein, based on qualifiers of respective healthcare staff members. In this regard, the detailed description is provided below to explain the foregoing in more detail.

The converter 210 serves to convert the contents of the text transmitted from the healthcare staff terminal 100 into the voice of a healthcare staff member who is in charge of preparing the text, and is described in more detail below.

The patient terminal 300 may function as a gateway to connect the patient with the healthcare staff members, and include a transmitter-receiver part 320 to receive text information sent by the healthcare staff members to the patient, as well as voice information obtained by converting the text information into the voice of the healthcare staff member; and an output part 310 to display visual and/or auditory information.

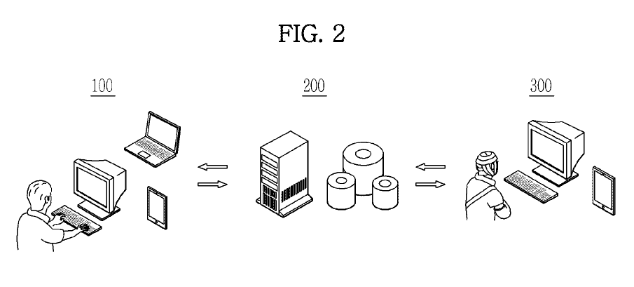

FIG. 2 illustrates overall system configuration according to an exemplary embodiment. As shown in FIG. 2, the healthcare staff terminal part 100 may be any electronic device capable of storing and managing information, as for example, a personal computer (PC), a mobile instrument such as a notebook computer, a smartphone, a personal digital assistant (PDA), and so forth, and communicating with other devices, the configuration of which is not limited. The server 200 may also be any electronic device capable of storing and managing information and communicating with other devices, the configuration of which is not limited. For example, a device having a large information storage capability and capable of transmitting the information may be used. Like the healthcare staff terminal 100, the patient terminal 300 may also be any electronic device capable of storing and/or managing information and communicating with other devices, as for example, a PC, a mobile instrument such as a notebook computer, a smartphone, a PDA, and so forth, the configuration of which is not limited.

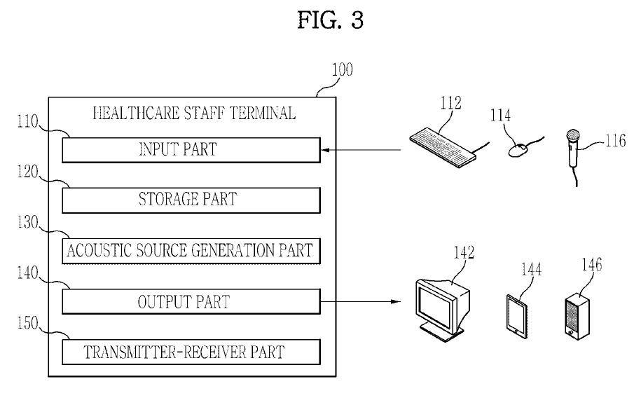

FIG. 3 is a control block diagram of a healthcare staff terminal 100 in a remote healthcare system according to an exemplary embodiment. As shown in FIG. 3, the healthcare staff terminal 100 may include an input part 110, a storage part 120, an acoustic source generation part 130, an output part 140, and a transmitter-receiver part 150.

The input part 110 receives text from the healthcare staff member to be transmitted to a patient, a voice required for extracting an acoustic source, or an acoustic source test result, wherein the text or the test result is input through input means such as a keyboard 112 or a mouse 114 of a PC, a text pad of a smartphone, etc., while the voice is input via a microphone 116 equipped in the healthcare staff terminal 100 or connected to/from an external device. The above-mentioned input means are only examples and other means for inputting the text or voice may be employed without limitation to the configuration thereof. The storage part 120 may store data including, for example, input text, recorded voice or created acoustic source, or the like.

The acoustic source generation part 130 is configured to extract an acoustic source from the voice of the healthcare staff member and is described in more detail below.

The output part 140 may have a configuration for outputting visual or audio data with desired purposes to the healthcare staff member via various output devices. For example, the visual output is provided using an output device such as a monitor 142 of a PC or a liquid crystal display 144 of a smartphone, while the audio output is obtained using an output device such as a speaker 146. Such output means are only examples and the configuration thereof is not limited so long as the output device outputs visual or auditory information.

The transmitter-receiver part 150 may be configured for sending and receiving data between the server 200 and the healthcare staff terminal 100 or the patient terminal 300 and the healthcare staff terminal 100.

As described above, the server 200 may be provided with an acoustic source database 220 to store acoustic sources of healthcare staff members, in order to convert text of a healthcare staff member into the voice of the same. Since the acoustic source database is constructed of acoustic sources provided by the healthcare staff members, the healthcare staff terminal 100 has the acoustic source generation part 130 provided therein to create the acoustic source of the healthcare staff member, in turn transmitting the created acoustic source to the server 200.

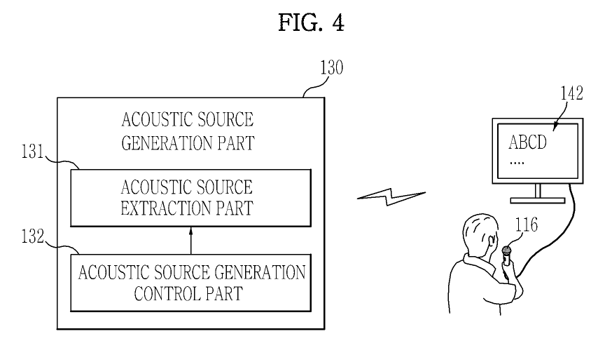

FIG. 4 is a block diagram illustrating an acoustic source generation part. The acoustic source generation part 130 may include an acoustic extraction part 131 to isolate an acoustic source from recorded voices of medical practitioners and an acoustic source generation control part 132 to control a process of creating the acoustic source.

When the healthcare staff member records words or sentences for extracting a whole acoustic source, the acoustic source generation control part 132 outputs the words or sentences through the output part 140 and the healthcare staff member pronounces the foregoing words or sentences through the input part 110 and records the same.

The acoustic extraction part 131 may extract an acoustic source from the voice of the healthcare staff member input through the input part 110. More particularly, the acoustic extraction part 131 divides the recorded voice of the healthcare staff member through the input part 110 into phonemes and analyzes the same and creates and stores an inherent text-to-speech (TTS) codec on the basis of the analyzed voice. Other than the foregoing, various methods for extracting acoustic sources may be employed without being limited to the above-described.

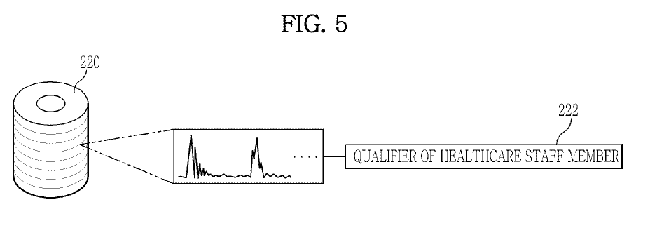

The acoustic source of the healthcare staff member extracted from the acoustic source extraction part 131 may be transmitted to the server 200 and then stored in the acoustic source database 220. FIG. 5 is a schematic view illustrating an acoustic source database 220 having the acoustic source of the healthcare staff member stored therein. The acoustic source database 220 may include all acoustic sources stored therein, from which words or sentences can be converted into the voice of each of the healthcare staff members.

The acoustic source of a healthcare staff member may be stored according to a qualifier of the healthcare staff member 222, since the acoustic source is transmitted together with the qualifier from the healthcare staff terminal 100. The qualifier of a healthcare staff member may be an ID directly set by the healthcare staff member or, otherwise, a name or an inherent identification number of the healthcare staff member. Such forms are not limited and, the server 200 may impart the qualifier to the healthcare staff member. The qualifier may be utilized to detect the acoustic source of the healthcare staff member when the healthcare staff member prepares text.

If the acoustic source of the healthcare staff member is stored in the acoustic source database 220, an acoustic source may be extracted from the acoustic source database 220 and the text may be converted into voice using the extracted acoustic source whenever the healthcare staff member inputs text, without recording the voice or extracting the acoustic source. Accordingly, the healthcare staff member may confirm whether a correct acoustic source is stored in the acoustic source database 220, which is described below in more detail.

The acoustic source generation part 130 of the healthcare staff terminal 100 in the remote healthcare system according to an exemplary embodiment may further include a test part to confirm whether there is an error in extracting the acoustic source.

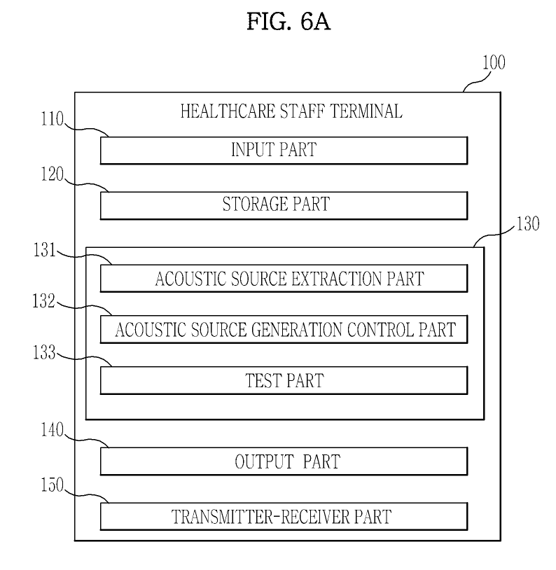

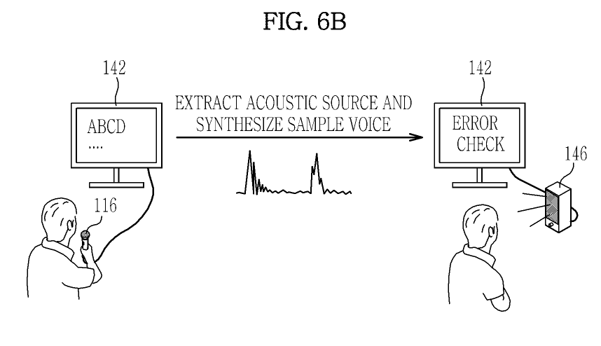

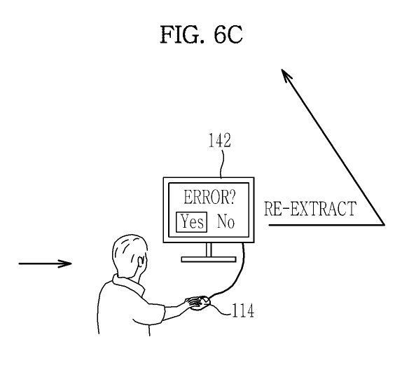

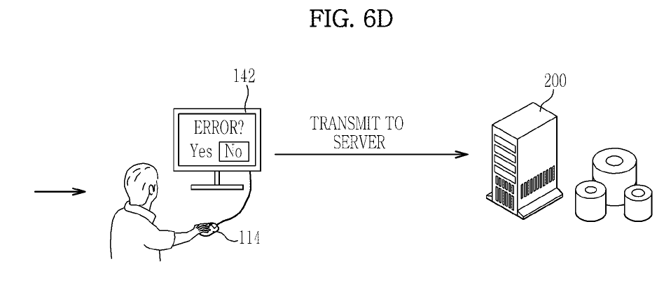

FIG. 6A illustrates a block diagram of the healthcare staff terminal 100 having the test part. As shown in FIG. 6A, the healthcare staff terminal may include the acoustic source generation part 130 for creating an acoustic source of the healthcare staff member. The acoustic source generation part 130 may include the test part 133 to determine whether there is an error in extracting the acoustic source. The test part 133 uses the acoustic source of the healthcare staff member extracted from the acoustic source extraction part 131 to synthesize a sample voice, wherein the test part 133 may have a voice synthesizer or may use the converter 210 in the server 200. The test part 133 provides the synthesized sample voice to the healthcare staff member through the output part 140. Thus, a determination whether there is an error in the sample voice, such as inaccurate pronunciation of the sample voice, awkward intonation, etc. may be made. Thus, the healthcare staff member listens to the sample voice and the results of the determination are input through the input part 110.

FIG. 6B is a schematic view illustrating a test performed using the test part 133. As shown in FIG. 6B, words or sentences to extract an entire acoustic source of a healthcare staff member by the acoustic source generation control part 132 in the acoustic source generation part 130 are video output or audio output. Then, if the healthcare staff member pronounces the words or sentences and inputs the same into the input part 110, the acoustic source is extracted using the voice of the healthcare staff member input through the input part 110, by the acoustic source extraction part 131. The test part 133 may have a voice changer or send the extracted acoustic source to the converter 210 of the server 200 to synthesize a sample voice.

The test part 133 outputs an audio of the synthesized sample voice through the output part 140, enabling the healthcare staff member to hear the same. Then, the healthcare staff member may determine whether there is an error in extracting the acoustic source by listening to the sample voice.

As shown in FIG. 6D, when no error in the sample voice is confirmed after listening to the sample voice, the healthcare staff member inputs the result (no error in the sample voice) to the input part 110, and the acoustic source generation part 130 sends a desired acoustic source to the transmitter-receiver part 150, which transmits the same to the server 200. Here, a qualifier of the healthcare staff member is also transmitted to distinguish the transmitted acoustic source from the acoustic sources of other healthcare staff members.

As shown in FIG. 6C, when an error is present in the sample voice after checking the sample voice, that is, if there is a problem such as a substantial difference between the sample voice and the actual voice of the healthcare staff member, awkward intonation or pronunciation, etc., the healthcare staff member inputs the result (error in the sample voice) to the input part 110. If the entirety of the sample voice has the error, the whole sample voice is selected. On the other hand, if the error is partially present in a specific part of the sample voice, another acoustic source required for synthesizing the voice at the erroneous part may be extracted again by selecting the specific part.

After inputting a signal to indicate an error in the sample voice, the test part 133 outputs a word or a sentence corresponding to the acoustic source to be re-extracted through the output part 140, enabling the healthcare staff member to pronounce the word or sentence and input the same to the input part 110.

The acoustic source extraction part 131 may re-extract an acoustic source at the erroneous part using the re-input voice, while the test part 133 or the converter 210 of the server 200 may re-synthesize a sample voice using the re-extracted acoustic source.

The test part 133 outputs the re-synthesized sample voice and repeatedly receives an input indicating whether the sample voice has an error by the healthcare staff member. The test part 133 may repeat the foregoing process, until a signal indicating that the sample voice does not have any error, is received.

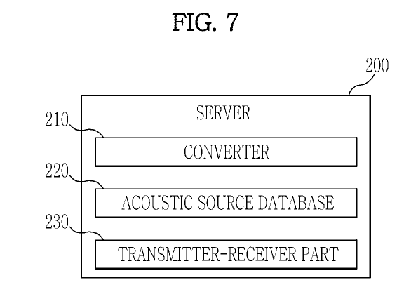

FIG. 7 is a block diagram illustrating a server 200 according to an exemplary embodiment. The server 200 may include an acoustic source database 220 to store acoustic sources of healthcare staff members, a transmitter-receiver part 230 to send and receive data from a healthcare staff terminal 100 and/or a patient terminal 300, and a converter 210 to change text into voice using the acoustic sources of the healthcare staff members.

As described above, the acoustic source database 220 may include acoustic sources of the healthcare staff members who use a remote healthcare system, wherein the acoustic sources are stored together with respective qualifiers of the healthcare staff members to allow synthesis of voice using the acoustic source of the healthcare staff members who prepared the text.

The converter 210 changes the text transmitted from the healthcare staff terminal 100 into the voice of the same healthcare staff member. One of the techniques to change the text into the voice is ‘Text-to-Speech (TTS)’ and an exemplary embodiment may employ this technique or other appropriate techniques for the synthesis of voice based on the contents of a given text using an acoustic source extracted from human voice.

The transmitter-receiver part 230 may receive an acoustic source or text of the healthcare staff member from the healthcare staff terminal 100 and information regarding health conditions of a patient or a message forwarded to the healthcare staff member by the patient. In order to transmit voice information and text information generated in the server 200 to the patient terminal 300, a file mode of the voice information may include any one capable of loading the voice therein such as a wave file, an MP3 file, etc., and the text information may also be of any file type without limitation thereto.

The remote healthcare system according to the present exemplary embodiment may send a message changed into the voice of a healthcare staff member together with text message which is transmitted by the healthcare staff member, to a patient, in order to effectively manage the patient. Therefore, the text may be converted into the voice of the healthcare staff member who is in charge of the patient.

Accordingly, the server 200 of the remote healthcare system according to an exemplary embodiment may further include an acoustic source detector to detect acoustic sources of the healthcare staff members.

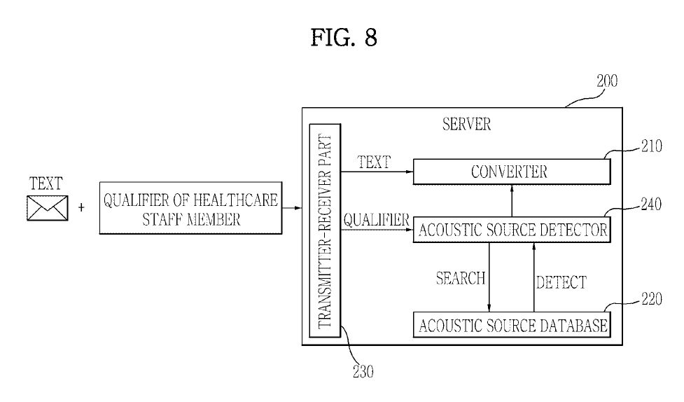

FIG. 8 is a control block diagram of the server 200 including the acoustic source detector. As described above, the transmitter-receiver part 150 of the healthcare staff terminal 100 transmits a qualifier of the healthcare staff member as well as the text input by the healthcare staff member. The transmitter-receiver part 230 of the server 200, that has received the qualifier of the healthcare staff member as well as the text, transmits the received qualifier to the acoustic source detector 240.

The acoustic source detector 240 may compare the qualifier of the healthcare staff member transmitted from the transmitter-receiver part 230 with qualifiers of the acoustic sources stored in the acoustic source database 220, and detect the acoustic source having a specific qualifier.

When the acoustic source having the specific qualifier is detected by the acoustic source detector 240, the acoustic source may be transmitted to the converter 210. The converter 210 may use the transmitted acoustic source from the acoustic source detector 240 to change the text transmitted from the transmitter-receiver part 230 of the server 200 into the voice of the healthcare staff member.

When the text is transmitted to the converter 210, a grammar structure of the text is analyzed and then, on the basis of the analyzed text structure, a prosodic phrase similar to reading by a person may be created, followed by a waveform synthesis process by collecting basic units of the detected acoustic source according to the created prosodic phrase and then converting the text into the voice. A method for conversion of the text into voice neither has restrictions nor is limited to the foregoing exemplary embodiment.

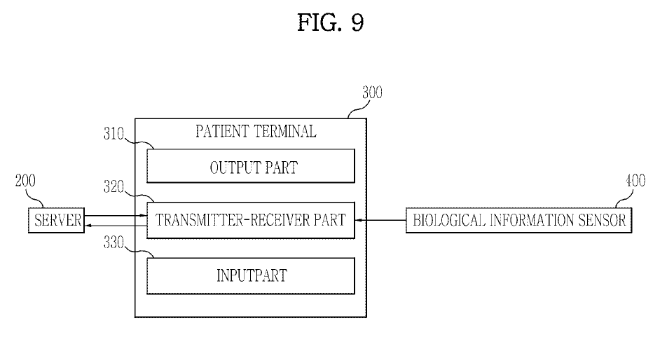

FIG. 9 is a control block diagram illustrating a patient terminal 300 in a remote healthcare system according to an exemplary embodiment. The patient terminal 300 may include a transmitter-receiver part 320 capable of sending and receiving information from the server 200 or from a biological information sensor 400, an output part 310 to output the text or voice message transmitted from a healthcare staff member, and an input part 330 to input the text or voice message to be provided by a patient to the healthcare staff member.

The transmitter-receiver part 320 may receive a text message or voice message from the server 200, wherein the message is provided by the healthcare staff member to the patient. The text message is input by the healthcare staff member through the healthcare staff terminal 100, while the voice message is obtained by changing the text message into the voice of the healthcare staff member who is in charge of the patient in the server 200 having the text message transmitted thereto.

The output part 310 may output the text message or voice message received by the transmitter-receiver part 320. In this case, either the text message or the voice message may be output depending upon preference of the patient or, otherwise, both messages may be output. In the case in which the voice message is output, the patient directly hears the message via the voice of the healthcare staff member who is in charge of the patient, thereby an interaction between the healthcare staff member and the patient is improved, and an experience similar to that of visiting a healthcare center is created, for the patient. Moreover, transmission effects may also be improved, compared to message transfer through text only.

Where the patient wishes to inform the healthcare staff members of certain subject matter, the patient may input such matter through the input part 330 in any input mode including text and voice. For example, if a text mode is used for input, a keyboard or mouse of a PC, a text pad of a smartphone, etc., may be utilized. On the other hand, when using a voice mode to input the subject matter, a microphone equipped in the patient terminal 300 or connected to/from the external device may be employed.

The transmitter-receiver part 320 may receive information regarding health conditions of a patient from the biological information sensor 400 provided at the patient side, wherein the biological information sensor measures the health conditions, and transmit the received information to the server 200. As described above, the biological information sensor 400 may measure blood glucose, blood pressure, body weight, body fat, heart rate or the like of the patient, while the server 200 may send the information regarding the health conditions of the patient transmitted thereto to the healthcare staff terminal 100.

When the information regarding the health conditions of the patient is transmitted from the transmitter-receiver part 320 to the server 200, a qualifier of the corresponding patient is also sent. Here, like the qualifier of the healthcare staff member, the qualifier of the patient may be an ID directly set by the patient, an actual name of the patient, or an inherent qualifier imparted by the server 200. That is, any information capable of distinguishing individual patients may be utilized. Moreover, the qualifier of a healthcare staff member who is in charge of a healthcare section indicated by the information regarding the health conditions of the patient may be forwarded together with the foregoing. Alternatively, the healthcare staff member who is in charge of the patient may be searched using the qualifier of the patient and the corresponding information in the server 200.

After receiving the information regarding the health conditions of the patient from the transmitter-receiver part 320, the server 200 may transmit the received information to the healthcare staff terminal 100, while the healthcare staff terminal 100 may directly confirm and/or check the health conditions of the patient through the output part 140 and/or use a clinical decision support system (CDSS) or a decision support system for home healthcare (DSSH) to analyze the health conditions of the patient, in turn conducting diagnosis of the patient and/or writing a prescription for the same. In addition, the healthcare staff member may input a text message to be sent to the patient, based on the diagnosis and the prescription, and transmit the message in a voice form to the patient. Such a process is described in detail above.

The server 200 of the remote healthcare system according to an exemplary embodiment may transmit the information regarding the health conditions of the patient received from the patient terminal 300 to the healthcare staff member or may execute diagnosis of the patient and/or issue a prescription for the same by itself in the server 200 simultaneously with transmitting the information.

For such a purpose, the server 200 may include a CDSS and/or a DSSH. The CDSS refers to a system supporting a medical decision by using professional medical knowledge in a computer software form, while the DSSH is an information system designed on the basis of fundamental knowledge to support a decision for healthcare. Both foregoing systems analyze the information regarding the health conditions of the patient and support the decision for diagnosis or prescription for the patient. The CDSS is restricted to supporting the decision of a medical practitioner, while the DSSH includes an overall home healthcare region as well as the decision of the medical practitioner. According to an exemplary embodiment, the server 200 may have the CDSS or DSSH. For example, the server having the CDSS is described in detail below.

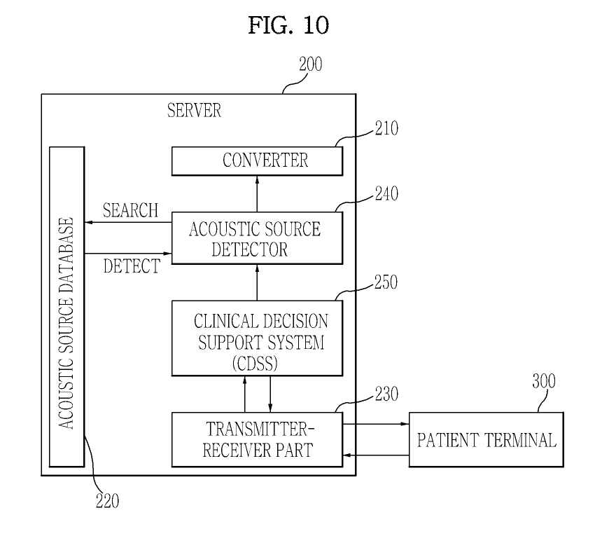

FIG. 10 is a block diagram illustrating functions of a server 200 having the CDSS. Referring to FIG. 10, the transmitter-receiver part 230 may transmit the information regarding the health conditions of the patient received from the patient terminal 300, to the CDSS 250. The CDSS 250 analyzes the information regarding the health conditions of the patient transmitted thereto, executes diagnosis and/or prescription matching with the corresponding patient, and creates a text to be sent to the patient. Moreover, in order to detect an acoustic source of the healthcare staff member who is in charge of the health condition information, a signal is sent to the acoustic source detector 240.

For instance, if the patient is a diabetic and the health condition information sent by the patient terminal 300 relates to a blood glucose level of the patient, the acoustic source detector 240 detects an acoustic source of a medical practitioner who is in charge of diabetic treatment of the patient. For this purpose, in addition to qualifiers of healthcare staff members corresponding to respective acoustic sources in the acoustic source database 220, qualifiers of patients and healthcare fields may also be included.

The qualifier of the healthcare field may indicate a healthcare application of which the healthcare staff member is in charge of and which, for example, includes diabetic care, heart disease care, renal disease care, obesity care, etc. Since these healthcare applications have separate qualifiers, the acoustic source of the healthcare staff members, who are in charge thereof, may be detected using the qualifiers of the healthcare applications.

The acoustic source detector 240 compares the qualifier of the healthcare field in connection with the received health condition information as well as the qualifier of the patient with the qualifiers stored in the acoustic source database 220, thus detecting the acoustic source of the healthcare staff member in charge. Moreover, based on contents of the text created in the CDSS, the qualifier of the healthcare staff member may be extracted, and the respective acoustic source of the healthcare staff member may be detected.

If the patient terminal 300 simultaneously transmits the qualifier of the healthcare staff member or the qualifier of the healthcare staff member is extracted based on the contents of the text created in the CDSS 250, the acoustic source detector 240 may search for the qualifier of the healthcare staff member in the acoustic source database 220. The acoustic source detector 240 detects the acoustic source of the healthcare staff member, and then, transmits the detected acoustic source to the converter 210.

The converter 210 uses the received acoustic source to change the diagnosis result or the content of the prescription into voice in the CDSS 250 and, through the transmitter-receiver part 230, allows transmission of the changed result to the patient terminal 300.

As described above, the remote healthcare system has a structure of changing text information sent by a healthcare staff member into a voice, in a server 200. The patient terminal 300 may have a structure of changing the text information into the voice and may have a converter mounted on or in the patient terminal 300, as described in detail below.

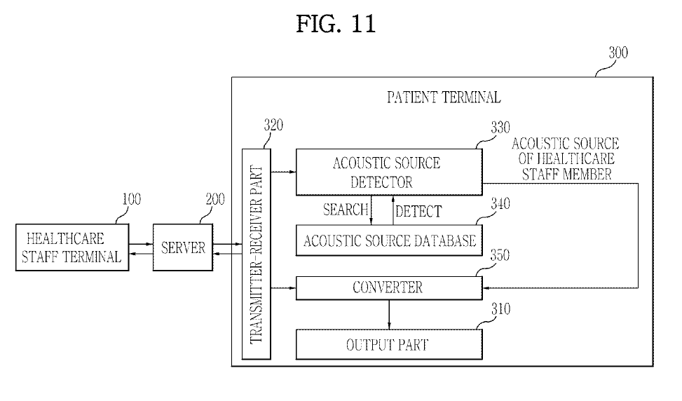

FIG. 11 is a control block diagram of a remote healthcare system including a patient terminal 300 equipped with a converter, according to an exemplary embodiment. The healthcare staff terminal 100 may have substantially the same configuration as described above. Also, the server 200 may include a converter, an acoustic source detector and an acoustic source database, as described above. However, the patient terminal 300 according to the present exemplary embodiment may include a transmitter-receiver part 320, an acoustic source detector 330, an acoustic source database 340 containing acoustic sources of healthcare staff members, a converter 350 and an output part 310.

The acoustic source database 350 of the patient terminal 300 may include acoustic sources of healthcare staff members who are in charge of respective patients, which are stored together with qualifiers of the healthcare staff members or qualifiers of healthcare fields. Unlike the acoustic source database 220 in the server 200, all of the acoustic sources of the healthcare staff members using the remote healthcare system are not stored but only the acoustic sources of the healthcare staff members who are in charge of the patients are stored. Accordingly, the acoustic source database 350 neither possesses a large volume nor takes a long time to detect the acoustic source.

When the healthcare staff member inputs text information to be sent to the patient through the healthcare staff terminal 100, the transmitter-receiver part of the healthcare staff terminal 100 transmits the text information together with the qualifiers of the healthcare staff member and the patient to the server 200. The transmitter-receiver part of the server 200 does not send the text information to the acoustic source detector in the server 200 but, instead, transmits the same to the transmitter-receiver part 320 of the patient terminal 300 having the qualifier of the patient. In this case, the qualifier of the healthcare staff member is concurrently forwarded.

The transmitter-receiver part 320 of the patient terminal 300 receives the qualifier of the healthcare staff member as well as the text information from the server 200, and transmits the received qualifier of the healthcare staff member to the acoustic source detector 330. The received text information may be sent to the converter 350.

The acoustic source detector 330 may compare the received qualifier of the healthcare staff member with the qualifiers of the acoustic sources stored in the acoustic source database 340 in the patient terminal 300, and detect the acoustic source of the healthcare staff member and transmit the detected acoustic source to the converter 350.

The converter 350 may convert the text information received from the transmitter-receiver part 320 into the acoustic source of the healthcare staff member sent by the acoustic source detector 330. Similar to the converter of the server 200, voice conversion may include any method without limitation.

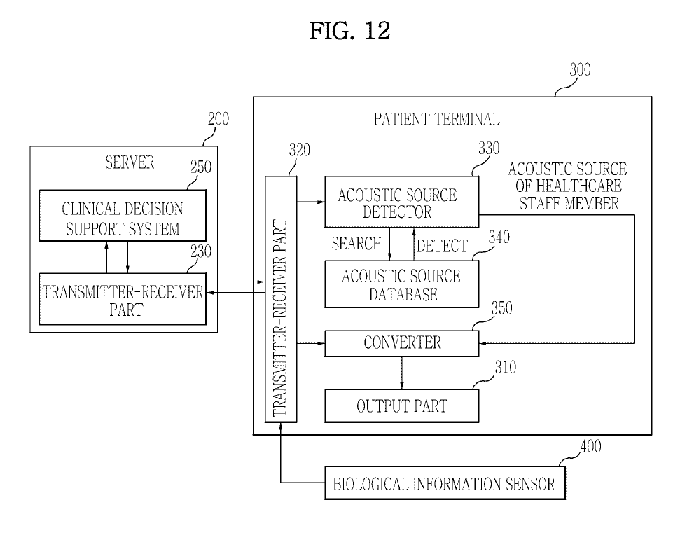

FIG. 12 is a control block diagram illustrating conversion of text information created by the CDSS 250 of the server 200 into voice in the patient terminal 300. As described above, if the server 200 has the CDSS 250, it is possible to analyze information regarding health conditions of the patient sent by a biological information sensor 400 provided at the patient side, in turn executing diagnosis of the patient or issuing a prescription for the same and creating a text related thereto.

If the server 200 does not have the converter 210 or, otherwise, in order to prevent an increase in data transmission or overload of the server 200 even though the server has the converter 210, the text may be changed into the voice in the patient terminal 300 which enables voice conversion.

In the case where the patient terminal 300 has the acoustic source database 340, the acoustic source detector 330 and the converter 350, the text information regarding diagnosis and/or prescription determined by the CDSS 250 may be forwarded to the patient terminal 300 and, concurrently, the server 200 may transmit the qualifier of the healthcare staff member who is in charge of the corresponding healthcare field. In this regard, the transmitter-receiver part 320 of the server 300 may send the received qualifier of the healthcare staff member to the acoustic source detector 330 and the acoustic source detector 330 may detect an acoustic source having the corresponding qualifier.

When the server 200 transmits the text information, the qualifier of the healthcare staff member may also be forwarded. In this case, the acoustic source detector 330 of the patient terminal 300 may compare the qualifier of the healthcare field with the qualifiers in the acoustic source database 340, thus detecting an acoustic source of the corresponding healthcare staff member.

If the qualifiers of the healthcare staff members and the respective healthcare fields are concurrently stored when the acoustic sources are stored in the acoustic source database 340, the acoustic source of the corresponding healthcare staff member may be successfully detected even though the qualifier is sent by the server 200.

As described above, if text information is converted into voice information in the patient terminal 300, the data transmission rate from the server 200 to the patient terminal 300 may be decreased, thus reducing load on the server 200.

A remote healthcare method according to an exemplary embodiment is described below in more detail.

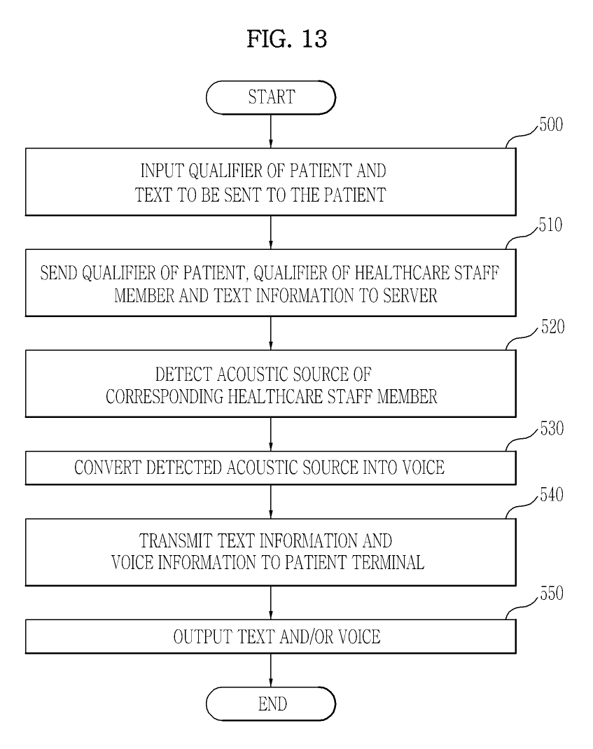

FIG. 13 is a flow diagram illustrating a remote healthcare method according to an exemplary embodiment. Referring to FIG. 13, the healthcare staff member may input a qualifier of a patient to whom a text is forwarded and the text to be sent to the patient, in a healthcare staff terminal (operation 500). The qualifier of the patient may be an inherent ID of the patient or an actual name of the patient, without being limited so long as the patient can be distinguished from other patients.

The contents of the text to be sent to the patient may include a diagnosis of health conditions of the patient or a prescription for the same based on an input received from a biological information sensing system provided at the patient side or may be prepared for regular management, without limitation as to the contents thereof.

The healthcare staff terminal may transmit the qualifier of the patient, the text information and/or the qualifier of the healthcare staff member, input by the healthcare staff member, to the server (operation 510). Like the qualifier of the patient, the qualifier of the healthcare staff member may be an inherent ID or an actual name of the healthcare staff member. That is, so long as the healthcare staff member can be distinguished from other staff members, contents of the qualifier are not limited. For convenience in detecting the acoustic source, the qualifier of the healthcare field managed by the healthcare staff member may be concurrently transmitted.

The acoustic source detector of the server compares the received qualifier of the healthcare staff member with the qualifiers of the acoustic sources stored in the acoustic source database, thus detecting an acoustic source of the corresponding healthcare staff member (operation 520).

The converter may change the text information sent by the healthcare staff member into voice information using the detected acoustic source (operation 530). Moreover, the changed information may be stored in a voice file form such as a wave file, an MP3 file, etc., capable of storing the voice information.

The voice file may be sent to the patient terminal corresponding to the qualifier of the patient and, simultaneously, the text information may also be forwarded (operation 540). The patient terminal may visually display the text information through the output part and also output the voice information via an audio output device (operation 550).

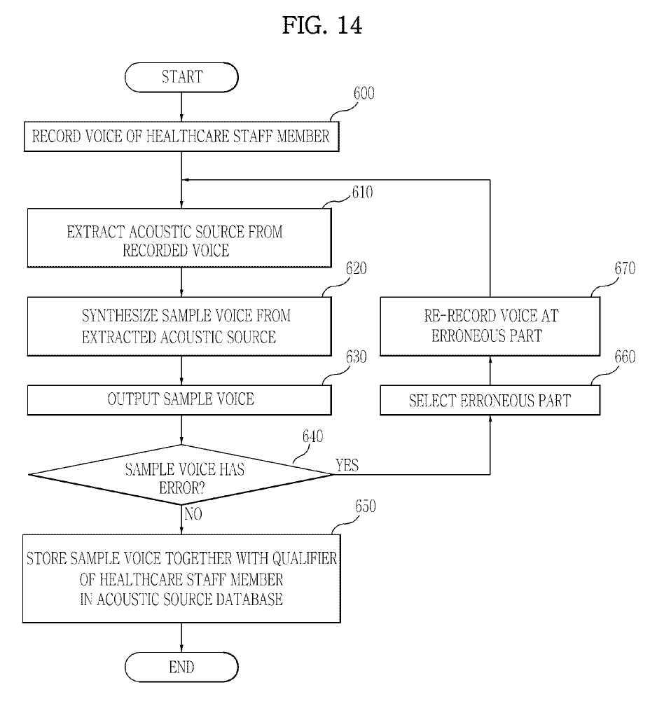

FIG. 14 is a flow diagram illustrating a method of constructing an acoustic source database according to an exemplary embodiment. First, a voice of the healthcare staff member is recorded (operation 600). Here, the healthcare staff member pronounces words or sentences used for extracting acoustic sources. Then, from the recorded voices of the healthcare staff member, a desired acoustic source is extracted (operation 610).

Following this, using the extracted acoustic source, a sample voice is synthesized (operation 620). The sample voice is used for the healthcare staff member to determine whether there is an error in the acoustic source extraction. The synthesis of the sample voice may be performed by directly mounting a voice synthesizer in the healthcare staff terminal or using the converter of the server.

After the synthesized sample voice is output (operation 630), the healthcare staff member determines whether the sample voice has any error. As a result of the determination, in the case where the sample voice is different from the actual voice of the same person or has problems in terms of pronunciation or intonation (operation 640, ‘YES’), parts containing identified problems may be input (operation 660).

If errors in the sample voice are input by the healthcare staff member, the healthcare staff member pronounces the words or sentences to extract a desired acoustic source corresponding to the erroneous part or parts, which are re-recorded (operation 670). Afterwards, a desired acoustic source may be repeatedly extracted from the recorded voices (operation 610) and used to synthesize a sample voice (operation 620).

The healthcare staff member may determine whether the synthesized sample voice has errors and the foregoing processes may be repeated. If the healthcare staff member has determined that the synthesized sample voice does not have any error (operation 640, ‘NO’), the extracted acoustic source as well as the qualifier of the healthcare staff member may be transmitted to the server. Here, if the qualifier of the healthcare field that is managed by the healthcare staff member is also forwarded together with the foregoing, this may be effectively used for detecting the acoustic source of the healthcare staff member.

The server may receive the acoustic source of the healthcare staff member and prepare a database (operation 650). In this regard, the qualifiers of the healthcare staff members may be stored as respective qualifiers of the acoustic sources and, in addition, the qualifier of the healthcare field may become the qualifier of the respective acoustic source.

Since the server includes acoustic sources of a plurality of healthcare staff members integrated into a database, a desired acoustic source of a specific healthcare staff member may be detected using the qualifiers of the acoustic sources including the qualifiers of the healthcare staff members and/or the qualifiers of the healthcare fields.

As described, a remote healthcare method utilizes a direct input mode to input the text by the healthcare staff member. A method for transmitting text information and/or voice information using a CDSS provided in the server is described in detail below.

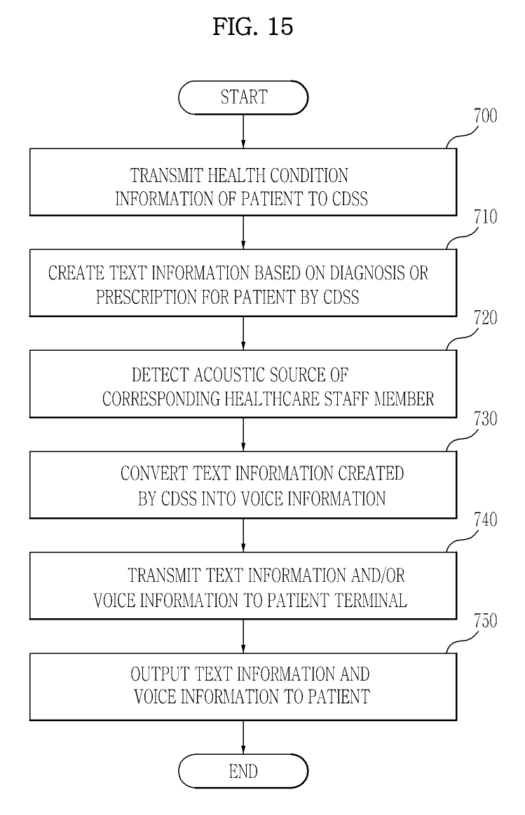

FIG. 15 is a flow diagram illustrating processes of transmitting text information and voice information using the CDSS. First, the CDSS may receive the health condition information of the patient measured by the biological information sensor provided at the patient side and the qualifier of the patient, through the patient terminal (operation 700). The health condition information may refer to data, by which the health conditions of the patient are determined by analyzing a blood glucose level, blood pressure, heart rate, body temperature, body weight, body fat, etc., of the patient, thus enabling diagnosis of the patient or prescription for the same.

The CDSS of the server may analyze the health condition information of the patient transmitted thereto, determine health conditions of the patient at present, conduct diagnosis and issue a prescription for the patient, and create text information regarding the foregoing matters (operation 710). For instance, the text information such as “Since your blood glucose level has increased, please take care of your dietary habits and visit the hospital within the week” may be created.

In order to convert the above text information into voice, an acoustic source of the corresponding healthcare staff member is detected (operation 720). For example, the acoustic sources of a plurality of healthcare staff members may be stored in the acoustic source database of the server. When the patient terminal transmits the health condition information of the patient, the qualifier of the corresponding healthcare field may be simultaneously transmitted or the server may use the health condition field to extract a qualifier of the healthcare field to determine the acoustic source of an appropriate staff member with higher accuracy.

The acoustic source may detect an acoustic source having a qualifier corresponding to the qualifier of the healthcare staff member as well as the qualifier of the patient in the acoustic source database, and transmit the same to the converter (operation 720). The converter may use the transmitted acoustic source, to convert the text information generated by the CDSS into voice information of the healthcare staff member (operation 730).

The converted voice information may be stored in a voice file type such as a wave file, an MP3 file, etc., and be transmitted together with the text information to the patient terminal corresponding to the qualifier of the patient. The patient terminal may output the voice information and/or the text information to the patient, through the output part (operation 750).

The above-described remote healthcare method may execute conversion of text information into voice information in the server. A remote healthcare method using a patient terminal equipped with a converter, in order to convert text information into voice information in the patient terminal, is described in more detail below.

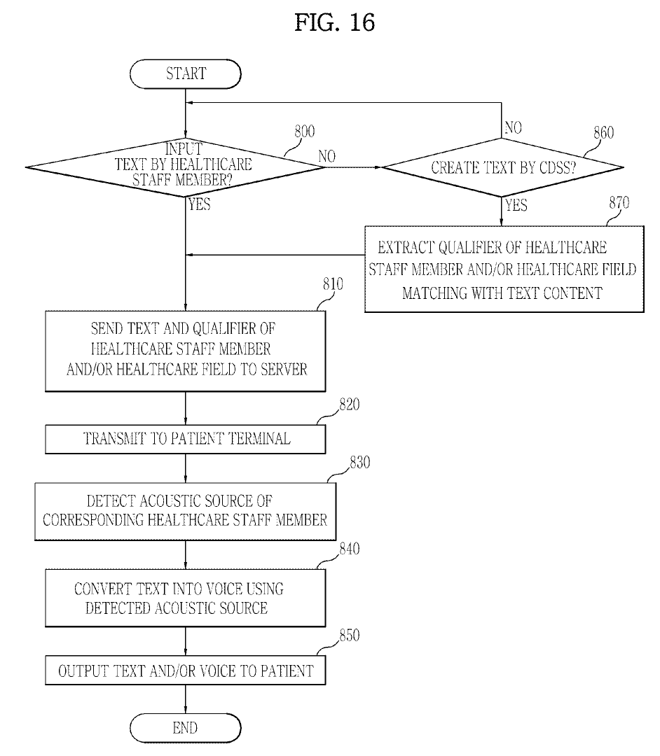

FIG. 16 is a flow diagram illustrating a remote healthcare method to convert text information into voice information in a patient terminal 300. In the case where the healthcare staff member creates text through a healthcare staff terminal 100 (operation 800, ‘YES’), the text information as well as a qualifier of the healthcare staff member are transmitted to the server 200 (operation 810). The server 200 may transmit the received text information and the qualifier of the healthcare staff member to a patient terminal 300 (operation 820). The patient terminal 300 may detect an acoustic source having a qualifier corresponding to the qualifier of the healthcare staff member transmitted thereto, from an acoustic source database (operation 830). The converter may change the text information transmitted from the server 200 into the voice of the corresponding healthcare staff member, using the detected acoustic source (operation 840). Following that, the text information and voice information are output to the patient through the output part (operation 850).

If a text was generated in the CDSS of the server 200 (operation 800, ‘NO’; operation 860, ‘YES’), the qualifier of the healthcare field may be sent together with the text to the patient terminal 300 (operation 810). Additionally or alternatively, a qualifier of the healthcare staff member who is in charge of the healthcare field related to the text content, or in a charge of the patient, may be searched, and the qualifier of the healthcare staff member may also be extracted (operation 870) and transmitted. The patient terminal 300 which uses the qualifier of the healthcare field or the qualifier of the healthcare staff member, may detect the acoustic source of the corresponding healthcare staff member (operation 830) and convert the text information into voice using the same (operation 840). The text information and/or the voice information may be output to the patient through the output part (operation 850).

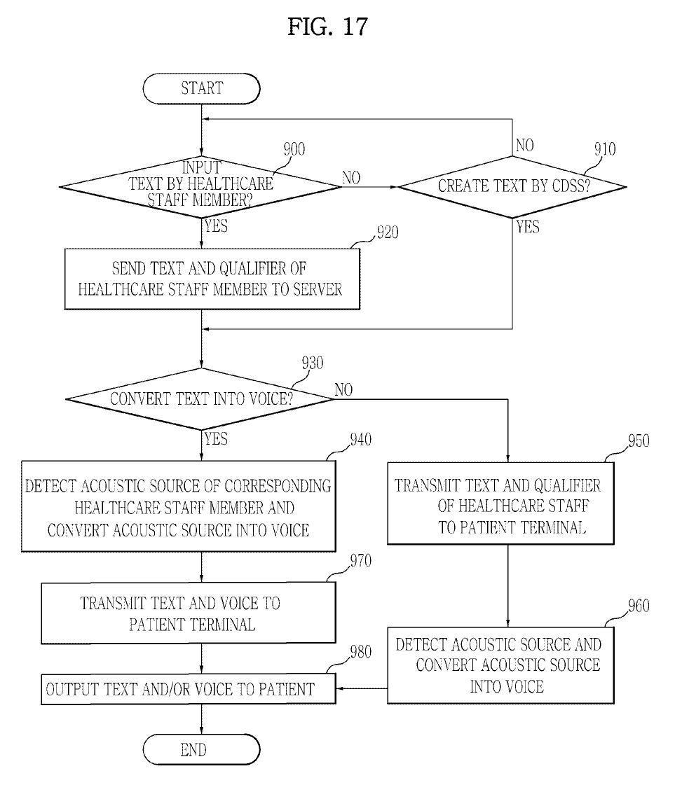

FIG. 17 is a flow diagram illustrating a remote healthcare method wherein both a server 200 and a patient terminal 300 are provided with converters.

Referring to FIG. 17, if the healthcare staff member directly creates a text (operation 900, ‘YES’), a qualifier of the healthcare staff member, a qualifier of a patient to receive the text and text information may be transmitted to the server 200 (operation 920). In the case where the converter of the server 200 is used to improve the quality of the converted voice (operation 930, ‘YES’), an acoustic source having a qualifier, which corresponds to the qualifier of the healthcare staff member in an acoustic source detector of the server 200, is detected from the acoustic source database. The converter may use the detected acoustic source to change the text information into the voice information (operation 940), and transmit the text information and the voice information to the patient terminal 300 corresponding to the qualifier of the patient (operation 970). The patient terminal 300 may output the text information and/or the voice information through the output part to the patient (operation 980).

If the converter in the patient terminal 300 is provided, to reduce load and data transmission rate of the server 200 (operation 930, ‘NO’), the qualifier of the healthcare staff member as well as the text information transmitted to the server 200 may be forwarded to the patient terminal 300 corresponding to the qualifier of the patient (operation 950). The acoustic source detector of the patient terminal 300 may detect an acoustic source having a qualifier, which corresponds to the transmitted qualifier of the healthcare staff member, from the acoustic source database, while the converter may change the transmitted text information into the voice of the healthcare staff member, using the detected acoustic source (operation 960). The text information and/or the voice information may be output to the patient through the output part (operation 980).

Instead of creating the text by the healthcare staff member, when the CDSS of the server 200 generates the text (operation 900, ‘NO’; and operation 910, ‘YES’), a qualifier of the healthcare field or a qualifier of the healthcare staff member related to the generated contents of the text may be detected and then transmitted together with the text, to the patient terminal 300 which has a qualifier corresponding to the qualifier of the patient (operation 950), in order to use the converter of the patient terminal (operation 930, ‘NO’). The acoustic source detector of the patient terminal 300 may detect the acoustic source of the healthcare staff member, using the qualifier of the healthcare field or the qualifier of the healthcare staff member. On the other hand, the converter may convert the text information (operation 930, ‘YES’) into voice information, using the detected acoustic source (operation 940). The output part may output the text information and/or the voice information to the patient (operation 980).

In the case where the text created in the CDSS is changed into voice in the server (operation 930, ‘YES’), the qualifier of the healthcare staff member or the qualifier of the healthcare field may be extracted from the text and, using the extracted qualifier, an acoustic source of the healthcare staff member related to contents of the text may be detected. Using the detected acoustic source, the text may be converted to the voice of the healthcare staff member (operation 940). The text and the converted voice are transmitted to the patient terminal (operation 970) and output to the patient through the output part (operation 980).

According to exemplary embodiments, a patient may receive diagnosis, prescription and/or healthcare by the voice of the healthcare staff member even though the patient does not visit a healthcare center. The remote healthcare system is not restricted to transfer of various instructions for diagnosis, prescription or healthcare through text and, instead, may also transmit an acoustic message formed of the voice of a healthcare staff member who is in charge of the patient, thereby improving interaction between the patient and the healthcare staff members and effectively executing healthcare of the patient.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A remote healthcare system comprising:
a healthcare staff terminal which includes an input part configured to input text to be transmitted to a patient by a healthcare staff member, and a first transmitter-receiver part configured to transmit the text and a qualifier of the healthcare staff member;
a server which includes a second transmitter-receiver part configured to receive the text and the qualifier of the healthcare staff member transmitted from the healthcare staff terminal, an acoustic source database having an acoustic source of the healthcare staff member stored therein, and a converter configured to change the text into voice using the stored acoustic source of the healthcare staff member; and
a patient terminal which includes a third transmitter-receiver part configured to receive the voice converted from the text and the text transmitted by the second transmitter-receiver part of the server, and an output part configured to output the voice to the patient who is managed by the healthcare staff member.

2. The remote healthcare system according to claim 1, wherein the server further includes an acoustic source detector that detects an acoustic source having a qualifier, which corresponds to the qualifier of the healthcare staff member received from the first transmitter-receiver part, in the acoustic source database, and provides the detected acoustic source to the converter.

3. A remote healthcare system comprising:
a healthcare staff terminal which includes an input part configured to input text to be transmitted to a patient by a healthcare staff member, and a first transmitter-receiver part configured to transmit the text and a qualifier of the healthcare staff member;
a server having a second transmitter-receiver part configured to receive the text and the qualifier of the healthcare staff member transmitted from the healthcare staff terminal; and
a patient terminal which includes a third transmitter-receiver part configured to receive the text and the qualifier of the healthcare staff member transmitted by the second transmitter-receiver part of the server, an acoustic source database which stores an acoustic source of the healthcare staff member, a converter configured to change the text into voice of the healthcare staff member, and an output part configured to output the converted voice and the text.

4. The remote healthcare system according to claim 3, wherein the patient terminal further includes an acoustic source detector that detects an acoustic source having a qualifier, which corresponds to the qualifier of the healthcare staff member received from the second transmitter-receiver part, in the acoustic source database, and provides the detected acoustic source to the converter.

5. A healthcare staff terminal comprising:
an input part into which a healthcare staff member inputs text to be transmitted to a patient; and
a transmitter-receiver part that transmits the text together with a qualifier of the healthcare staff member to a server configured to convert the text into a voice of the healthcare staff member and send the voice to a patient terminal.

6. The healthcare staff terminal according to claim 5, further comprising:
an acoustic source generation part configured to create an acoustic source of the healthcare staff member, and
an output part configured to output at least one of the text and the voice.

7. The healthcare staff terminal according to claim 6, wherein the acoustic source generation part includes:
an acoustic source extraction part configured to extract an acoustic source from the voice of the healthcare staff member input to the input part;
an acoustic source control part configured to control a process of creating the acoustic source; and
a test part configured to test whether the extracted acoustic source has any error.

8. The healthcare staff terminal according to claim 7, wherein the test part uses the acoustic source extracted by the acoustic source extraction part to synthesize a sample voice,
outputs the sample voice through the output part, and
receives an input, from the healthcare staff member, to determine whether the sample voice has any error.

9. The healthcare staff terminal according to claim 8, wherein, if the input part receives an input indicating that the sample voice has an error, the test part outputs a word or a sentence to re-extract an acoustic source through the output part, and
receives the word or the sentence in a voice form from the healthcare staff member through the input part.

10. The healthcare staff terminal according to claim 9, wherein the test part repeats an extraction of the acoustic source and an output of the sample voice until an input indicating that the sample voice does not have any error is received, and
if the input indicating that the sample voice does not have any error is received, transmits the extracted acoustic source to the server through the transmitter-receiver part.

11. A server comprising:
a transmitter-receiver part that receives a text and a qualifier of a healthcare staff member from a healthcare staff terminal or transmits the text and a voice changed from the text to a patient terminal;
an acoustic source database which stores acoustic sources of healthcare staff members; and
a converter that changes the text received from the healthcare terminal into the voice, using the stored acoustic sources of the healthcare staff members.

12. The server according to claim 11, further comprising an acoustic source detector that detects an acoustic source having a qualifier, which corresponds to the qualifier of the healthcare staff member received from the healthcare terminal, in the acoustic source database, and provides the detected acoustic source to the converter.

13. The server according to claim 12, wherein the converter converts the text received from the healthcare staff terminal into the voice, using the acoustic source provided by the acoustic source detector.

14. The server according to claim 11, wherein the transmitter-receiver part receives information regarding health conditions of a patient transmitted from the patient terminal.

15. The server according to claim 14, further comprising:
a decision support system for home healthcare (DSSH) configured to create text corresponding to a diagnosis or prescription, using the information regarding the health conditions of the patient transmitted from the patient terminal.

16. The server according to claim 15, wherein the acoustic source detector detects an acoustic source of the healthcare staff member matching with contents of the text created by the DSSH and provides the detected acoustic source to the converter, and
the converter changes the text created by the DSSH into the voice by using the acoustic source provided by the acoustic source detector.

17. The server according to claim 16, wherein the acoustic source detector detects an acoustic source having a qualifier, which corresponds to one of a qualifier of the healthcare staff member matching with the text content and a qualifier of a healthcare field matching with the text content, in the acoustic source database.

18. A patient terminal comprising:
a transmitter-receiver part configured to receive text from a server;
an acoustic source database which stores acoustic sources of healthcare staff members;
an acoustic source detector configured to detect an acoustic source of a healthcare staff member who prepared the text, in the acoustic source database;
a converter configured to change the text into a voice of the healthcare staff member, by using the detected acoustic source; and
an output part configured to output the text and the voice which is converted from the text.

19. The patient terminal according to claim 18, wherein the transmitter-receiver part receives a qualifier of the healthcare staff member who prepared the text from the server, and
the acoustic source detector detects the acoustic source having a qualifier corresponding to the qualifier of the healthcare staff member in the acoustic source database, and provides the detected acoustic source to the converter.

20. The patient terminal according to claim 18, wherein the transmitter-receiver part receives a text created by a decision support system for home healthcare DSSH) of the server, from the server, and
the acoustic source detector detects the acoustic source of the healthcare staff member matching with text content, and transmits the detected acoustic source to the converter.

21. The patient terminal according to claim 20, wherein the acoustic source detector detects the acoustic source having a qualifier, which corresponds to one of a qualifier of the healthcare staff member matching with the text content and a qualifier of a healthcare field matching with the text content, in the acoustic source database.

22. A remote healthcare method comprising:
inputting a text to be transmitted to a patient, by a healthcare staff member;
converting the text into a voice of the healthcare staff member; and
outputting the voice of the healthcare staff member and the text to the patient.

23. The remote healthcare method according to claim 22, wherein the converting the text into the voice of the healthcare staff member includes:
detecting an acoustic source having a qualifier, which corresponds to the qualifier of the healthcare staff member, in the acoustic source database, by an acoustic source detector of a server; and
using the detected acoustic source to change the text into the voice of the healthcare staff member by a converter of the server.

24. The remote healthcare method according to claim 22, wherein the converting the text into the voice of the healthcare staff member includes:
detecting an acoustic source having a qualifier, which corresponds to the qualifier of the healthcare staff member, in the acoustic source database, by an acoustic source detector of a patient terminal; and
using the detected acoustic source to change the text into the voice of the healthcare staff member, by a converter in the patient terminal.

25. A remote healthcare method comprising:
creating a text related to a diagnosis or a prescription data of a patient in a decision support system for home healthcare (DSSH) to execute the diagnosis or a prescription based on information regarding health conditions of the patient;
converting the created text into a voice of a healthcare staff member matching with text content; and
outputting the created text and the voice of the healthcare staff member converted from the text, to the patient.

26. The remote healthcare method according to claim 25, wherein the converting the created text into the voice of the healthcare staff member includes:
extracting a qualifier of the healthcare staff member matching with the text content;
detecting an acoustic source having the qualifier matching with the extracted qualifier of the healthcare staff member, in the acoustic source database; and
using the detected acoustic source to change the created text into the voice of the healthcare staff member.

27. A method comprising:
generating text related to a diagnosis or a prescription data of a patient based on health conditions of the patient, in a healthcare staff terminal;
identifying a qualifier of a healthcare professional;
converting the generated text into a voice of the healthcare professional based on the identified qualifier; and
outputting at least one of the generated text and the converted voice of the healthcare professional at a remote patient terminal which is remotely connected to the healthcare staff terminal.

28. The method of claim 27, wherein the identifying the qualifier of the healthcare professional comprises at least one of:
receiving the qualifier which identifies the healthcare professional as an input, and
identifying the qualifier of the healthcare professional based on text content.

29. The method of claim 28, wherein the converting comprises:
in advance, storing acoustic sources of healthcare professionals together with respective identifying qualifiers of the healthcare professionals;
detecting the acoustic source having the qualifier matching with the identified qualifier of the healthcare professional; and
using the detected acoustic source to convert the generated text into the voice of the healthcare professional.
